(19) United States
(12) Patent Application Publication
(10) Pub. No.: US 2025/0272174 A1
(43) Pub. Date: Aug. 28, 2025

(54) CRASH LOG COLLECTION ARCHITECTURE FOR DISAGGREGATED DIE PRODUCTS

(71) Applicant: Intel Corporation, Santa Clara, CA (US)

(72) Inventors: Mariecel Torres-Young, Portland, OR (US); Youvedeep, Hillsboro, OR (US)

(73) Assignee: Intel Corporation, Santa Clara, CA (US)

(21) Appl. No.: 18/584,892

(22) Filed: Feb. 22, 2024

(51) Int. Cl. G06F 11/07

(52) U.S. Cl. CPC G06F 11/0778; G06F 11/0721; G06F 11/079

(57) ABSTRACT

Methods and apparatus relating to a crash log collection architecture for disaggregated die products are described. In one embodiment, an integrated circuit device (e.g., a semiconductor package such as an SOC, NOP, SOP, and so on) includes a plurality of dielets coupled via one or more communication links. Two or more dielets from the plurality of dielets each include a storage device to store a crash log. Logic circuitry on at least one dielet from the plurality of dielets causes storage of the crash log in the storage device in response to detection of a failure. Other embodiments are also disclosed and claimed.

### FIELD OF THE INVENTION

The present disclosure generally relates to the field of processors. More particularly, some embodiments relate to a crash log collection architecture for disaggregated die products.

### BACKGROUND OF THE INVENTION

Generally, a legacy crash log is a customer-visible debug feature that collects useful catastrophic failure information upon occurrence of a system crash, helping various providers (such as Original Equipment Manufacturers (OEMs), Operating System (OS) developers, hardware engineers, etc.) to diagnose failures, improve quality, and time to market. However, such legacy crash logs may only support events on a single integrated circuit die.

### BRIEF DESCRIPTION OF DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 depicts an example of two dielets coupled through four links or interconnects, in accordance with various embodiments.

FIG. 2 illustrates a block diagram of a sample architecture for a disaggregated crash log implementation, according to an embodiment.

FIG. 3 illustrates a flow diagram of a method to provide a disaggregated crash log implementation, according to an embodiment.

FIG. 4 illustrates an example computing system.

FIG. 5 illustrates a block diagram of an example processor and/or System on a Chip (SOC) that may have one or more cores and an integrated memory controller.

### DETAILED DESCRIPTION OF THE INVENTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As discussed above, legacy crash logs may only support events on a single integrated circuit die. As a result, such legacy solutions are unable to scale for multi-die next generation products. For example, with legacy solutions, the crash log records are not retained over a global reset and are inaccessible.

Moreover, some Central Processing Unit (CPU), Network On Chip (“NOC” or “NoC”), System On Package (“SOP” or “SoP”), and/or System On Chip (“SoC” or “SOC”) designs are moving toward disaggregating into multiple constituent “dielets” (also interchangeably referred to herein as “chiplets”). As discussed herein, a “chiplet” or “dielet” generally refers to an integrated circuit device (such as an integrated circuit die) that may include one or more functional blocks capable of performing one or more operations. For example, a dielet may be included on a semiconductor package or SOC to perform one or more operations associated with tasks such as compute, networking, storage, acceleration, etc. Moreover, each dielet may contain a complex subsystem that can be designed, developed, and validated by an individual team, sometimes with a different process technology than other dies/dielets on the system.

To this end, some embodiments provide a crash log collection architecture for disaggregated die products. In one embodiment, a disaggregated crash log collection architecture allows for faster and/or more efficient crash log collection across different dielets used on an SOC, NOP, SOP, or any other semiconductor package. In an embodiment, an integrated circuit device (e.g., a semiconductor package such as an SOC, NOP, SOP, and so on) includes a plurality of dielets coupled via one or more communication links. Two or more dielets from the plurality of dielets each include a storage device to store a crash log. Logic circuitry on at least one dielet from the plurality of dielets causes storage of the crash log in the storage device in response to detection of a failure. The stored data may then be fetched (e.g., after a reboot) by a central logic or other logic from the storage device for further processing, e.g., to determine the cause of the failure.

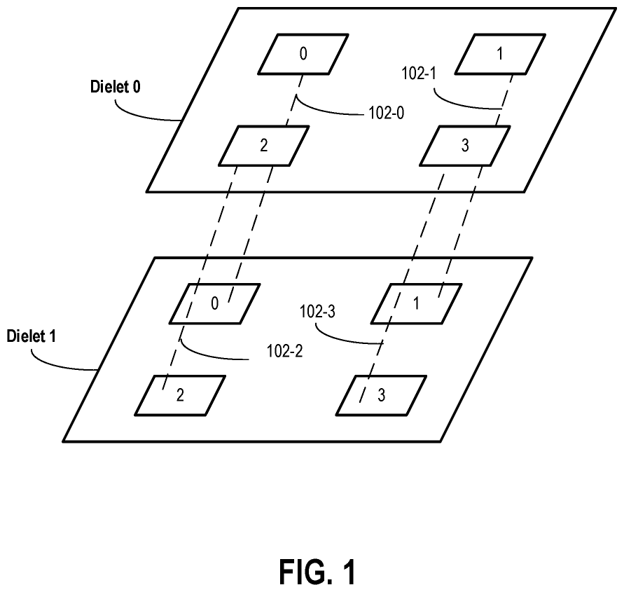

In some embodiments, two or more dielets may be coupled using multiple independent modules (or functional or Intellectual Property (IP) blocks numbered 0 to 3 on each dielet 0 and 1), as shown in FIG. 1. As used herein, the term “module,” “functional block,” or “IP block” may refer to, be part of, or include an Application Specific Integrated Circuit (ASIC) device, an electronic circuit, a processor (shared, dedicated, or group), and/or memory (shared, dedicated, or group) that executes one or more software or firmware programs, a combinational or computational logic circuit, and/or other components that provide the described functionality.

More specifically, FIG. 1 depicts an example of two dielets coupled through four links or interconnects 102-0 to 102-3 (such as Universal Chiplet Interconnect express-Three Dimensional (UCIe-3D) interconnects). In this example, the functional blocks (0 to 3) are coupled using a two dimensional (2D) mesh topology. However, in other embodiments, other topologies may be supported and/or more or less functional blocks may be provided on each dielet. In at least one embodiment, the common functionality across all physical layers (PHYs) may be managed by a common/shared control/logic block in the dielet or the package to amortize the overhead. In One embodiment, the two or more dielets may be provided on the same semiconductor package.

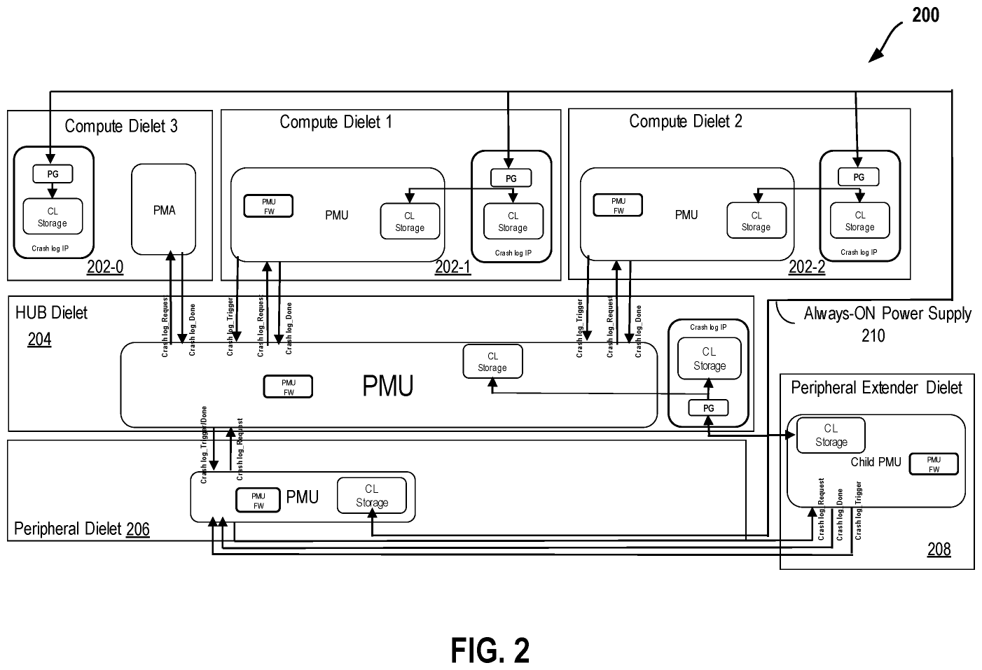

FIG. 2 illustrates a block diagram of a sample architecture 200 for a disaggregated crash log implementation, according to an embodiment. As an example, the disaggregated architecture may included two or more dielets including one or more compute dielets 202 (three compute dies 202-0 to 202-2 are shown in FIG. 2), a hub dielet 204, a peripheral dielet 206, and/or a peripheral extender dielet 208 (which may be used to extend the Input/Output (“IO” or “I/O”) ports on the system. As discussed herein, a “compute” dielet performs or executes one or more operations, e.g., in response to one or more instructions or commands. Furthermore, as discussed herein, a “hub” dielet performs one or more tasks to communicatively and/or operationally couple one or more dielets, as further discussed below.

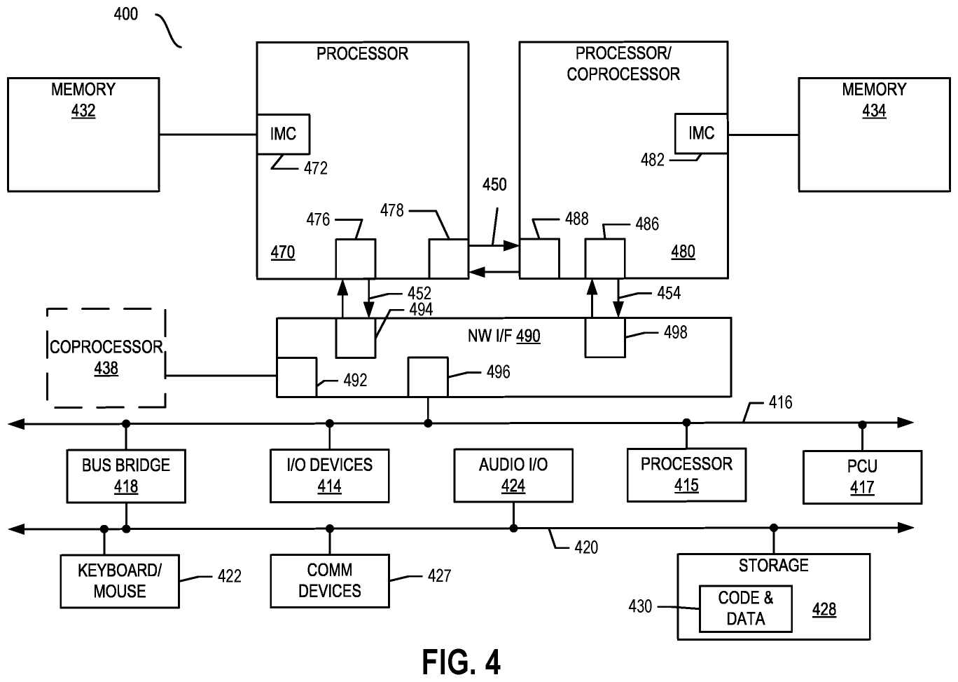

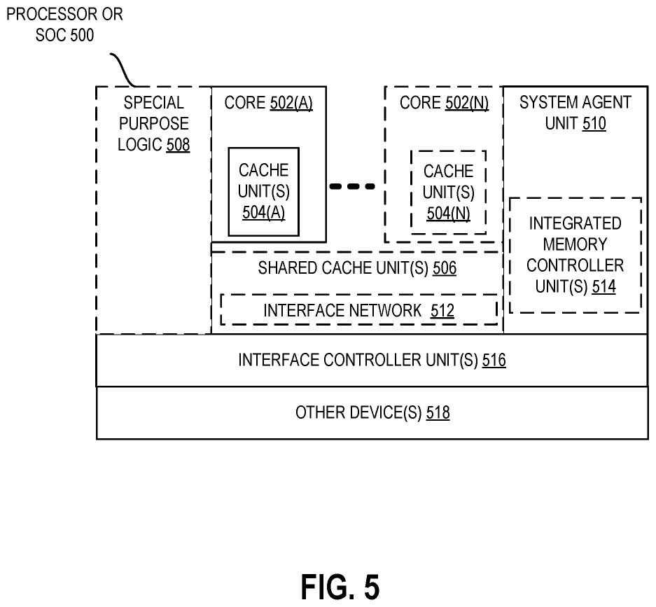

As shown, each dielet includes a crash log (CL) storage device to store a log of crash data. In an embodiment, logic circuitry (such as a processor, a Power Management Agent (PMA), a Power Management Unit (PMU), etc.) causes the storage of various types of data in the crash log in response to detection of an event such as a crash or failure. As discussed herein, a “failure” or “crash” generally refers to the occurrence of an error during operation in one or more components of a system/platform or a system-wide error such as a catastrophic error that prevents a system to further execute operations. In one embodiment, the CL storage device may be implemented as a static random access memory (SRAM) device, or other memory devices such as discussed with reference to FIGS. 4-5. In an embodiment, a power source or rail 210 continuously provides electrical power (hence, referred to herein as an “always-on” power supply) to the CL storage units provided on each dielet. One or more power gates (labeled as “PG”) in FIG. 2 may be used to control or convert the always-on power supply before providing power to the CL storage devices.

In one embodiment, a crash log IP block may include a PG logic and a CL storage such as shown for some of the dielets in FIG. 2. Moreover, FIG. 2 is but one example and embodiments are not limited to this illustration. For example, dielets 206 and 208 do not use a PG logic and are envisioned to utilized their local storage device for more than just crash log data storage (and may keep their local storage device in always on power state), while dielets 202-0 to 202-2 and 204 include a dedicated crash log storage device and may turn on or off their local storage device as needed. This new IP block (labeled “crash log IP”) may be dedicated to crash log collection, coupled to storage element that is ON only if there is a crash/failure log event on the system. Hence, the PG logic may control whether power is supplied to the corresponding CL storage selectively (e.g., only if a crash/failure log event is detected to allow for storage of crash related data on the CL storage device). Alternatively, power may be continuously provided to one or more of the CL storage devices depending on the implementation. This crash log IP's execution may be controlled by a power management agent (PMA) (which can be hardware-based or firmware based). The PMA may also be dedicated and present on the same dielet in an embodiment. This gives flexibility to a disaggregated design since it allows for a guided crash log collection sequence and storage to be on any dielet. The crash log IP may further allow for extraction of a collected crash log record by the OS or through a Joint Test Action Group (JTAG) test port.

Referring to FIG. 2, there are five dielets depicted and it shows the crash log IP on every dielet. The figure shows five dielets (202-1, 202-2, 204, 206, and 208) with a firmware-based component (PMU) controlling the crash log IP and one dielet (202-0) with a hardware based PMA block controlling the crash log IP.

FIG. 2 also shows that besides the dedicated crash log collection IP, there is crash log collection storage on the firmware based Power Management Units (PMUs) on the two compute dies and a third one on the hub dielet. All storages are on the Always-On power domain to allow retention of the crash log records over global resets. Each crash log collecting agent, firmware, or hardware, is capable of creating a record on their dedicated storage. In one embodiment, an increased storage with parallel collection allows for faster crash data collection system/SOC/SOP/NOC/package wide.

In one embodiment, the firmware based PMU on the hub dielet 204 may be designated as the central crash log control agent, which may direct one or more of other (or all) dielets on the system, SOC, or semiconductor package to start crash log collection through a dedicated crashlog_request wire/signal in response to detection of a crash/failure log event (see, e.g. the arrows between the hub dielet 204 and other dielets in FIG. 2). In at least one embodiment, all dielets perform crash log collection in parallel and report back to the central agent using crashlog_done wire/signal when their respective collection is complete. Crash even detection/trigger capable dielets may also notify the central crash log control agent via the crashlog_trigger wire/signal if a crash/failure log event has been detected or initiated on that dielet. These three wires/signals/links (e.g., crashlog_request, crashlog_done, and crashlog_trigger) may be dedicated wires or signals for the exclusive use of crash log on a disaggregated architecture design. This allows for communication between the central crash log agent and the dielets, while leaving the effort of crash log collection to each dielet. If a design removes, introduces or replaces a dielet, that dielet may be expected to have this three-wire interface (only two wires are needed if the dielet does not initiate crash log events) and to have an independent crash log collection flow in the event of a failure on the system. The three-wire interface is shown in FIG. 2 between the compute dielets 202-1/202-2 and the hub dielet 204, between the peripheral dielet 206 and the peripheral extender dielet 208. The two-wire interface is shown between the hub dielet 204 and the compute dielet 202-0, where compute dielet 202-0 does not initiate a crash log, thus only two wires/signals/links are utilized. Alternatively, the dedicated signals/wires may be implemented on a single wire or a point-to-point interconnect (e.g., as encoded signals), such as the links/interconnects 102-0 to 102-3 of FIG. 1.

As shown in FIG. 2, the Always-On power rail 210 is coupled to all crash log storage. The use of this power rail on all CL storage devices allows for the crash log record to survive different types of resets including a global reset.

Accordingly, some embodiments introduce new logic (including hardware and/or firmware) to support a crash log solution that is scalable, modular, and reliable for capturing crash information on (e.g., catastrophic) system failures for disaggregated CPU or semiconductor package/SOC designs. This is done by having distributed crash log collection through logic per dielet, and coordinated by a central agent.

More specifically, to provide modularity and scalability, each dielet is self-sufficient in crash/failure event detection, collection, and/or informing the central agent of the failure. This is achieved by each dielet having crash log dedicated firmware, storage, hardware including a wired/signaled interface with the central agent and a crash log IP. The dedicated wire/signal interface indicates whether the dielet has started/ended crash log and a request from the central agent if the crash log is initiated on a separate die.

To provide reliability, in the event of a crash or failure, if the on-chip system fabric (such as Intel® On-chip System Fabric (IOSF)) sideband network is inoperative, a crash log collection operation may still be performed using the dedicated wires/signals/links, allowing triggering and status communication between the dielets and the central crash log agent. This enhanced crash log solution may also include support for retaining the crash log record over all resets, including global resets. This allows debuggability of non-recoverable system failures after a system reset.

To improve debug capabilities, an embodiment provides one or more of: an increased data storage of debug information, less susceptibility to errors during status data collection in response to a crash that could prevent collection or loss of data, multiple localized per dielet storage devices allows for performance of crash log collection more gracefully in the event of fatal errors such as an on-chip system fabric failure in a dielet, impacting the crash log collection on certain sections of a multi-dielet semiconductor package/SOC.

In an embodiment, each dielet is 100% independent of the other dielets in terms of hardware and firmware for crash log collection. This approach ensures that as designs increment the number of dielets and/or mix/match various versions of dielets going forward, crash log collection operations are performed successfully.

By contrast, crash log implementations for previous generations of SOCs or processors are not scalable when compared to the new tiled, disaggregated architecture disclosed herein. Had the previous solution been used, the following would have been issues impacting the crash log feature:
Single agent bottleneck for crash log collection on all dielets.
Collection time would have been significantly higher due to no parallel crash capture.
Would have brought extra complexity in power management firmware.
Would cause excessive on-chip system fabric (such as IOSF) side band traffic across dielets during crash log collection.
Risk of not capturing any crash data from dielets if the inter-dielet on-chip system fabric network communication bridge is non-functional.
The central collection system and storage would need changes on any next generation dielet architecture changes.
The crash log execution time, storage size, reliability of obtaining crash data for debug on the event of a (e.g., catastrophic) failure would have been significantly impacted on disaggregated products.
Previous generations would not retain crash log over global resets.

In an embodiment, crash log control and capability settings may be added to a Basic Input/Output System (BIOS), such as for crash log storage on or off, for a clear command, etc.

In one embodiment, a Peripheral Component Interface express (PCIE) device parameter may be set to “10” to indicate crash log discovery or presence of a disaggregated crash log implementation. The PCIE device parameter generally shows a count of all the storage devices in use on the system (including, for example, the crash log storage devices). For a disaggregated crash log embodiment, this count would show a number higher than one (or higher than what any previous generations would have used).

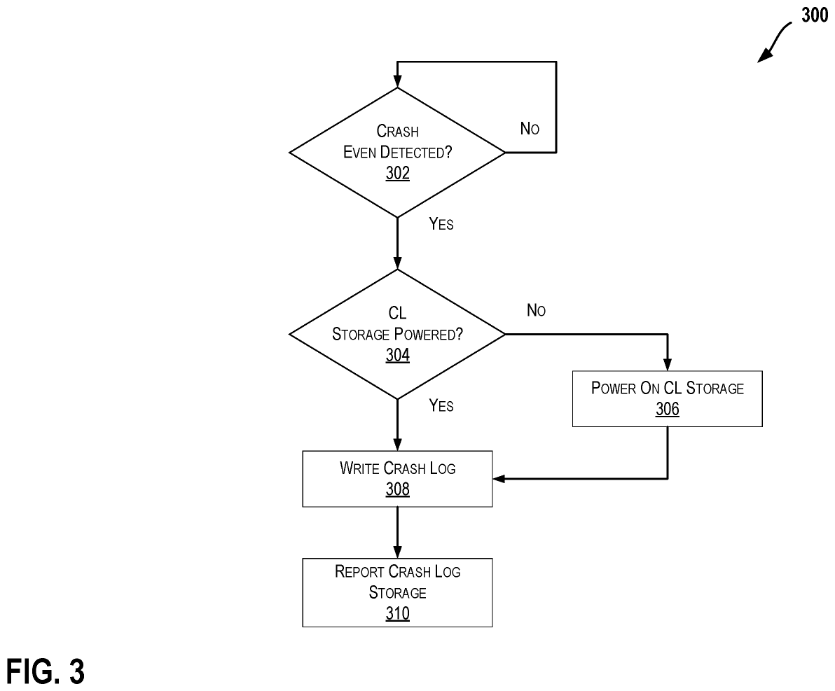

FIG. 3 illustrates a flow diagram of a method 300 to provide a disaggregated crash log implementation, according to an embodiment. In one or more embodiments, logic discussed with reference to FIG. 2 may be used to perform the operations of method 300.

Referring to FIGS. 1-3, at an operation 302, a crash or failure is detected (e.g., by logic present on a dielet or a central/hub dielet). At an operation 304, it is determined whether the corresponding dielet CL storage device is powered (e.g., via PG logic or other power management agent or unit). If the corresponding CL storage device is off, operation 306 powers on the CL storage. Method 300 resumes at operation 308 to write the crash log to the powered CL storage device. Operation 310 optionally reports the crash log completion (e.g., when requested by a central power management unit such as hub dielet PMU as discussed with reference to FIG. 2).

Moreover, one or more components discussed with reference to FIGS. 4-5 (including but not limited to I/O devices, memory/storage devices, graphics/processing cards/devices, network/bus/audio/display/graphics controllers, wireless transceivers, etc.) may be implemented as dielets on a SOC or NOC which communicate via the links/interconnects/signals discussed above with reference to FIGS. 1-3. Optionally, after operation 310, logic circuitry (e.g., the BIOS) may turn off the power to the crash log storage device on a corresponding dielet.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, Ultra-Mobile Personal Computer (UMPC), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430 and may implement the storage ‘ISAB03 in some examples. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 570 or 580, or co-processor 538 or 515 of FIG. 5.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller units circuitry 516 couple the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an integrated circuit device comprising: a plurality of dielets coupled via one or more communication links; and two or more dielets from the plurality of dielets to each include a storage device to store a crash log information, wherein logic circuitry on at least one dielet from the plurality of dielets is to cause storage of the crash log in the storage device in response to detection of a failure.

Example 2 includes the integrated circuit device of example 1, wherein the plurality of dielets comprise at least one of: a compute dielet, a hub dielet, and a peripheral dielet.

Example 3 includes the integrated circuit device of any one of examples 1 to 2, wherein the hub dielet is to comprise power management logic to request storage of the crash log information in a crash log storage device of a first dielet from the plurality of dielets.

Example 4 includes the integrated circuit device of any one of examples 1 to 3, wherein the hub dielet is to communicate with at least one of the compute dielet and the peripheral dielet via two or more links.

Example 5 includes the integrated circuit device of any one of examples 1 to 4, wherein the two or more links comprise two or more dedicated wires.

Example 6 includes the integrated circuit device of any one of examples 1 to 5, wherein the two or more links comprise two or more Universal Chiplet Interconnect express to Three Dimensional (UCIe to 3D) interconnects.

Example 7 includes the integrated circuit device of any one of examples 1 to 6, wherein the plurality of dielets comprise at least one of: a compute dielet, a hub dielet, a peripheral dielet, and a peripheral extender dielet.

Example 8 includes the integrated circuit device of any one of examples 1 to 7, wherein the hub dielet is to communicate with at least one of the compute dielet, the peripheral dielet, and the peripheral extender dielet via two or more links.

Example 9 includes the integrated circuit device of any one of examples 1 to 8, wherein the two or more links comprise two or more dedicated wires.

Example 10 includes the integrated circuit device of any one of examples 1 to 9, wherein the two or more links comprise two or more Universal Chiplet Interconnect express to Three Dimensional (UCIe to 3D) interconnects.

Example 11 includes the integrated circuit device of any one of examples 1 to 10, comprising logic to supply power to the storage device continuously.

Example 12 includes the integrated circuit device of any one of examples 1 to 11, comprising logic to supply power to the storage device upon detection of the failure.

Example 13 includes the integrated circuit device of any one of examples 1 to 12, wherein a hub dielet comprises the logic circuitry to cause storage of the crash log in the storage device in response to detection of the failure.

Example 14 includes the integrated circuit device of any one of examples 1 to 13, wherein the storage device comprises a static random access memory (SRAM) device.

Example 15 includes the integrated circuit device of any one of examples 1 to 14, wherein the one or more communication links comprise one or more interconnects.

Example 16 includes the integrated circuit device of any one of examples 1 to 15, wherein the one or more communication links comprise one or more UCIe to 3D interconnects.

Example 17 includes a system comprising: a plurality of dielets coupled via one or more communication links; at least one compute dielet from the plurality of dielets to execute one or more instructions; and two or more dielets from the plurality of dielets to each include a storage device to store crash log information, wherein logic circuitry on at least one dielet from the plurality of dielets is to cause storage of the crash log in the storage device in response to detection of a failure.

Example 18 includes the system of example 17, wherein the plurality of dielets further comprise at least one of: a hub dielet, a peripheral dielet, and a peripheral extender dielet.

Example 19 includes the system of any one of examples 17 to 18, comprising logic to supply power to the storage device continuously.

Example 20 includes the system of any one of examples 17 to 19, wherein the plurality of dielets comprise at least one of: a hub dielet, a peripheral dielet, and a peripheral extender dielet.

Example 21 includes an apparatus comprising means to perform a method as set forth in any preceding example.

Example 22. Machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

Further, while various embodiments described herein may use the term System-on-a-Chip or System-on-Chip (“SoC” or “SOC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system may have one or more processors (e.g., one or more processor cores) and associated circuitry (e.g., I/O circuitry, power delivery circuitry, etc.) arranged in a disaggregated collection of discrete dies, tiles, and/or chiplets (e.g., one or more discrete processor core die arranged adjacent to one or more other die such as a memory die, I/O die, etc.). In such disaggregated devices and systems, the various dies, tiles, and/or chiplets may be physically and/or electrically coupled together by a package structure including, for example, various packaging substrates, interposers, active interposers, photonic interposers, interconnect bridges, and the like. The disaggregated collection of discrete dies, tiles, and/or chiplets may also be part of a System-on-Package (“SoP”).

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An integrated circuit device comprising:
a plurality of dielets coupled via one or more communication links; and
two or more dielets from the plurality of dielets to each include a storage device to store a crash log information,
wherein logic circuitry on at least one dielet from the plurality of dielets is to cause storage of the crash log in the storage device in response to detection of a failure.

2. The integrated circuit device of claim 1, wherein the plurality of dielets comprise at least one of: a compute dielet, a hub dielet, and a peripheral dielet.

3. The integrated circuit device of claim 2, wherein the hub dielet is to comprise power management logic to request storage of the crash log information in a crash log storage device of a first dielet from the plurality of dielets.

4. The integrated circuit device of claim 2, wherein the hub dielet is to communicate with at least one of the compute dielet and the peripheral dielet via two or more links.

5. The integrated circuit device of claim 4, wherein the two or more links comprise two or more dedicated wires.

6. The integrated circuit device of claim 4, wherein the two or more links comprise two or more Universal Chiplet Interconnect express-Three Dimensional (UCIe-3D) interconnects.

7. The integrated circuit device of claim 1, wherein the plurality of dielets comprise at least one of: a compute dielet, a hub dielet, a peripheral dielet, and a peripheral extender dielet.

8. The integrated circuit device of claim 7, wherein the hub dielet is to communicate with at least one of the compute dielet, the peripheral dielet, and the peripheral extender dielet via two or more links.

9. The integrated circuit device of claim 8, wherein the two or more links comprise two or more dedicated wires.

10. The integrated circuit device of claim 8, wherein the two or more links comprise two or more Universal Chiplet Interconnect express-Three Dimensional (UCIe-3D) interconnects.

11. The integrated circuit device of claim 1, comprising logic to supply power to the storage device continuously.

12. The integrated circuit device of claim 1, comprising logic to supply power to the storage device upon detection of the failure.

13. The integrated circuit device of claim 1, wherein a hub dielet comprises the logic circuitry to cause storage of the crash log in the storage device in response to detection of the failure.

14. The integrated circuit device of claim 1, wherein the storage device comprises a static random access memory (SRAM) device.

15. The integrated circuit device of claim 1, wherein the one or more communication links comprise one or more interconnects.

16. The integrated circuit device of claim 1, wherein the one or more communication links comprise one or more UCIe-3D interconnects.

17. A system comprising:
a plurality of dielets coupled via one or more communication links;
at least one compute dielet from the plurality of dielets to execute one or more instructions; and
two or more dielets from the plurality of dielets to each include a storage device to store crash log information,
wherein logic circuitry on at least one dielet from the plurality of dielets is to cause storage of the crash log in the storage device in response to detection of a failure.

18. The system of claim 17, wherein the plurality of dielets further comprise at least one of: a hub dielet, a peripheral dielet, and a peripheral extender dielet.

19. The system of claim 17, comprising logic to supply power to the storage device continuously.

20. The system of claim 17, wherein the plurality of dielets comprise at least one of: a hub dielet, a peripheral dielet, and a peripheral extender dielet.
